(19) United States
(12) Patent Application Publication
(10) Pub. No.: US 2023/0392559 A1
(43) Pub. Date: Dec. 7, 2023

(54) ENGINE EXHAUST BRAKING SYSTEM FOR EQUALIZING PRESSURES ACROSS EXHAUST VALVES DURING INTAKE STROKES

(71) Applicant: GM GLOBAL TECHNOLOGY OPERATIONS LLC, Detroit, MI (US)

(72) Inventor: Maqsood Rizwan ALI KHAN, Troy, MI (US)

(21) Appl. No.: 17/830,732

(22) Filed: Jun. 2, 2022

(51) Int. Cl. F02D 13/04; F02D 13/02; F02D 35/02

(52) U.S. Cl. CPC F02D 13/04; F02D 13/0242; F02D 2200/101; F02D 2200/024; F02D 35/023

(57) ABSTRACT

An engine exhaust braking system includes: a valve control system for controlling states of exhaust valves of an engine; and a control module including a memory configured to store an exhaust valve pressure equalization algorithm. The control module is configured to execute instructions of the exhaust valve pressure equalization algorithm. The instructions include: determining whether the engine is operating in an engine exhaust braking mode; and in response to the engine operating in the engine exhaust braking mode, controlling the valve control system to reopen one or more of the exhaust valves during corresponding intake strokes of the engine to equalize pressures between interior and exterior sides of the one or more exhaust valves.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to engine control systems, and more particularly to exhaust pressure control systems.

A vehicle may include an internal combustion engine (ICE), such as a diesel engine, and a turbocharger (or “turbo”) for increasing efficiency and power output of the ICE. The turbocharger typically includes a turbine and a compressor. Exhaust gas from the ICE is passed through the turbine and rotates a turbine wheel, which is attached to a compressor wheel of the compressor via a shaft. Rotation of the turbine wheel causes the compressor wheel to rotate, which in turn compresses intake air prior to be provided to the ICE. As additional air is injected into cylinders of the ICE, a proportional amount of increased fuel may also be injected into the cylinders and as a result power output of the ICE is increased.

### SUMMARY

An engine exhaust braking system is disclosed and includes: a valve control system for controlling states of exhaust valves of an engine; and a control module including a memory configured to store an exhaust valve pressure equalization algorithm. The control module is configured to execute instructions of the exhaust valve pressure equalization algorithm. The instructions include: determining whether the engine is operating in an engine exhaust braking mode; and in response to the engine operating in the engine exhaust braking mode, controlling the valve control system to reopen one or more of the exhaust valves during corresponding intake strokes of the engine to equalize pressures between interior and exterior sides of the one or more exhaust valves.

In other features, the engine exhaust braking system further includes an engine speed sensor configured to detect a speed of the engine. The control module is configured to control the reopening of the one or more of the exhaust valves based on the speed of the engine.

In other features, the reopening of the one or more exhaust valves is controlled and scheduled.

In other features, the control module is configured to reopen the one or more exhaust valves multiple times during the corresponding intake strokes of the engine.

In other features, the control module is configured to, during the corresponding intake strokes of the engine, reopen the one or more exhaust valves and then partially close the one or more exhaust valves to intermediate closed states and then gradually close the one or more exhaust valves to fully closed states.

In other features, time between when the one or more exhaust valves are in the intermediate partially closed states to time when the one or more exhaust valves are in the fully closed states is longer than time between when the one or more exhaust valves are reopened to time when the one or more exhaust valves are in the intermediate partially closed states.

In other features, the engine exhaust braking system further includes: a crankcase pressure sensor detecting pressure within a crankcase of the engine; and an exhaust pressure sensor or a turbocharger inlet pressure sensor detecting a pressure indicative of a pressure on an exhaust side of the one or more exhaust valves. The control module is configured, based on the pressure within the crankcase and the pressure indicative of the pressure on the exhaust side of the one or more exhaust valves, to estimate pressure differentials across the one or more exhaust valves, and based on the pressure differentials, reopen the one or more exhaust valves during the corresponding intake strokes of the engine.

In other features, the one or more exhaust valves are on weak cylinders of the engine, the weak cylinders refer to cylinders having the shortest amount of time to intake and compress air as compared to other cylinders of the engine.

In other features, the valve control system performs modified Jake Brake operation to reopen the one or more exhaust valves during the corresponding intake strokes of the engine.

In other features, a vehicle propulsion system includes: at least one sensor detecting one or more parameters of the engine; and the engine exhaust braking system. The engine is a diesel engine. The control module is configured to reopen the one or more exhaust valves based on the one or more parameters.

In other features, a method of equalizing pressures across exhaust valves of an engine is disclosed. The method includes: controlling states of the exhaust valves of the engine via a valve control system; determining whether the engine is operating in an engine exhaust braking mode; and in response to the engine operating in the engine exhaust braking mode, controlling the valve control system to reopen one or more of the exhaust valves during corresponding intake strokes of the engine to equalize pressures between interior and exterior sides of the one or more exhaust valves.

In other features, the method further includes: detecting a speed of the engine; and controlling the reopening of the one or more of the exhaust valves based on the speed of the engine.

In other features, the reopening of the one or more exhaust valves is controlled and scheduled.

In other features, the method further includes reopening the one or more exhaust valves multiple times during the corresponding intake strokes of the engine.

In other features, the method further includes, during the corresponding intake strokes of the engine, reopening the one or more exhaust valves and then partially closing the one or more exhaust valves to intermediate closed states and then gradually closing the one or more exhaust valves to fully closed states.

In other features, time between when the one or more exhaust valves are in the intermediate partially closed states to time when the one or more exhaust valves are in the fully closed states is longer than time between when the one or more exhaust valves are reopened to time when the one or more exhaust valves are in the intermediate partially closed states.

In other features, the method further includes: detecting pressure within a crankcase of the engine; detecting a pressure indicative of a pressure on an exhaust side of the one or more exhaust valves; and based on the pressure within the crankcase and the pressure indicative of a pressure on the exhaust side of the one or more exhaust valves, estimating pressure differentials across the one or more exhaust valves, and based on the pressure differentials, reopening the one or more exhaust valves during the corresponding intake strokes of the engine.

In other features, the one or more exhaust valves are on weak cylinders of the engine, the weak cylinders refer to cylinders having the shortest amount of time to intake and compress air as compared to other cylinders of the engine.

In other features, the method further includes performing modified Jake Brake operation via the valve control system to reopen the one or more exhaust valves during the corresponding intake strokes of the engine.

In other features, the method further includes: detecting one or more parameters of the engine; and reopening the one or more exhaust valves based on the one or more parameters.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle propulsion system including an engine exhaust braking system with an equalization module in accordance with the present disclosure;

FIG. 2 is a functional block diagram of a portion of the engine exhaust braking system including the equalization module in accordance with the present disclosure;

FIG. 3 is a plot of exhaust valve displacement (or lift) versus crankshaft angle illustrating uncontrolled reopening of an exhaust valve and controlled reopening of the exhaust valve in accordance with the present disclosure; and

FIG. 4 illustrates a method of equalizing pressures across exhaust valves of an engine in accordance with the present disclosure.

In the drawings, reference numbers may be reused to identify similar and/or identical elements.

### DETAILED DESCRIPTION

A diesel engine includes a valve control assembly for controlling opening and closing of intake and exhaust valves of cylinders of the engine. The valve control assembly may be mechanically and/or electronically controlled to open and close the intake and exhaust valves at set times in association with intake and exhaust strokes of the engine. This includes scheduled and controlled opening and closing of the valves.

An engine may be operated as an engine brake (or pump) in certain situations to supplement braking of a vehicle braking system. For example, if the vehicle is a large truck and is heading downhill and/or is pulling a large load, assisted braking may be needed to aid in maintaining vehicle stability, control and a target speed. The assisted braking may be provided by disabling an ignition system and/or firing of cylinders of the engine and using the engine as a pump to aid in slowing down and decelerating the vehicle. This is also referred to as operating the engine in a “motored” mode. A diesel engine may be operated as a pump when, for example, operating at speeds greater than a predetermined speed (e.g., 3200 revolutions-per-minute (RPM)). The predetermined speed is greater than a speed (e.g., 2800 RPM) at which the engine provides a peak amount of output torque.

A valve control system of an engine may be controlled to operate the engine as a pump. A valve control system and/or components thereof that, for example, open exhaust valves during and before ends of compression strokes to release compressed trapped gas from within cylinders of the engine and prevent compressed energy from returning to the engine, are referred to as a Jake Brake. This type of valve control system may thus be used to control the engine as a pump to reduce speed of the vehicle.

While operating as an engine brake (or in a motored mode), a VGT of a turbo of the engine may be closed and pressure within an exhaust manifold of the engine can build. The exhaust manifold pressure builds while pressures within cylinders of the engine remain low. As a result, exhaust valves can uncontrollably reopen during intake strokes of the engine. High exhaust back pressure causes the exhaust valves to open. The exhaust valves can abruptly close in such a fashion as to damage the exhaust valves. In an attempt to prevent the exhaust valves from opening in this manner, stiffer springs may be installed on the exhaust valves. However, the ability to prevent the exhaust valves from opening using stiffer springs is limited and can result in a less efficiently operating engine due to the force need to open the exhaust valves in a controlled manner during exhaust strokes.

The examples set forth herein include controlling a valve control system in a modified Jake Brake operation mode to reopen selective exhaust valves of an engine one or more times during intake strokes. This is done to relief pressures on exterior (or manifold) sides of the exhaust valves and as a result equalize pressures across the exhaust valves. By equalizing the pressures, uncontrollable exhaust valve reopening is mitigated and/or prevented.

The pressures across exhaust valves refer to i) the pressures on interior sides of the exhaust valves facing interiors of cylinders of the engine, and ii) the pressures on exterior sides of the exhaust valves facing a manifold (or header) of the engine. Selected ones of the exhaust valves are opened prior to or during a beginning portion of when pressures within the exhaust manifold (or header) increase. The exhaust valves may be gradually closed over an extended period of time to prevent pressure build up in the manifold (or header) and thus prevent the exhaust valves from uncontrollably opening and uncontrollably closing.

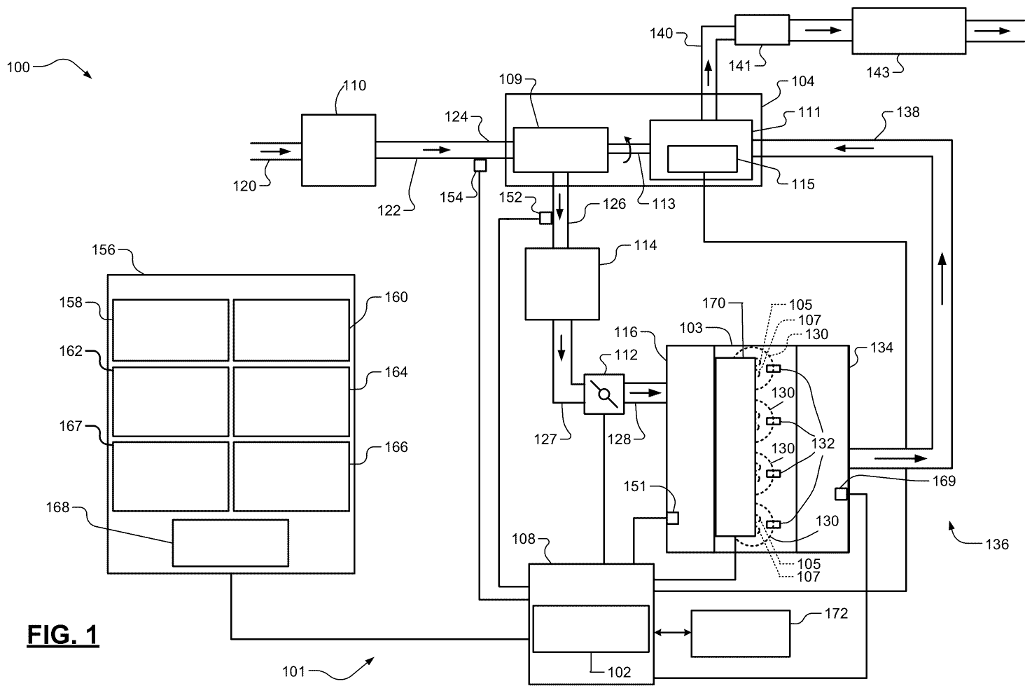

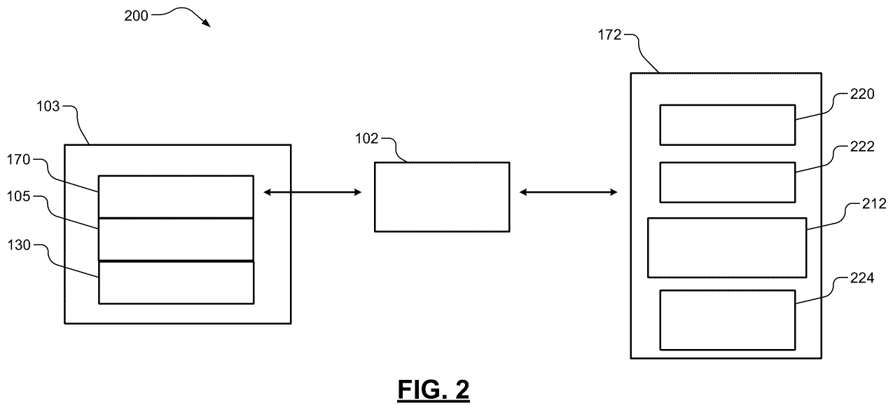

FIG. 1 shows an example vehicle propulsion system 100 including an engine exhaust braking system 101 including an equalization module 102 for equalizing pressures across exhaust valves 105 of an engine 103. A portion of the engine exhaust braking system 101 is shown in FIG. 2. Examples of operating the engine exhaust braking system 101 are described below with respect to FIGS. 1-4.

The vehicle propulsion system 100 further includes the turbocharger 104, and a vehicle control module 108. The turbocharger 104 includes a compressor 109 connected to a variable geometry turbine (VGT) 111 via a shaft 113. The VGT 111 includes a vane actuator 115 that actuates vanes within the VGT 111 to adjust speed of the VGT 111 and the boost pressure out of the compressor 109. The vehicle propulsion system 100 may include a closed loop control system for the turbocharger 104.

The engine 103 is a 4-stroke engine that may be a diesel engine or a gasoline engine. The gasoline engine systems may be alcohol-based, such as methanol, ethanol, and E85 based engine systems. The vehicle control module 108 controls operation of the engine 103.

The engine 103 combusts an air and fuel mixture to produce drive torque. Fresh air passes through an air filter 110 and is drawn into the turbocharger 104. The turbocharger 104 compresses the air, which is supplied to the engine 103. The greater the compression, the greater the output of the engine 103. The compressed air passes through a charged air cooler (CAC) 114 before entering an intake manifold 116 of the engine 103. Supply of air from the CAC 114 to the intake manifold 116 may be adjusted by a throttle 112. Conduits 120, 122, 124 and 126-128 are shown connected to the compressor 109, the air filter 110, the throttle 112, the CAC 114 and the intake manifold 116. Although shown as being located between the CAC 114 and the intake manifold 116, the throttle 112 may be implemented as part of the intake manifold 116.

Air within the intake manifold 116 is distributed into cylinders 130 of the engine 103. Fuel is injected into the cylinders 130 by fuel injectors 132. An air/fuel mixture in each of the cylinders 130 is combusted and creates exhaust gas. The exhaust gas exits the cylinders 130 into an exhaust manifold 134 of an exhaust system 136. The exhaust manifold 134 may be replaced with an exhaust header. An exhaust conduit 138 is connected to the exhaust manifold 134 and directs the exhaust gas to the VGT 111. The VGT 111 outputs the exhaust gas via conduit 140 to a catalytic converter (CC) 141 followed by a catalyst (underfloor) assembly 143, which may include an adsorber.

The vehicle control module 108 controls operation of the turbocharger 104 and the engine 103. The vehicle control module 108 adjusts boost pressure out of the engine 103 based on requested output torque and/or load of the engine 103. As an example, the boost pressure may be adjusted based on an amount of fuel requested. The vehicle control module 108 may generate a position control signal VP that is provided to the actuator 115 to adjust the boost pressure by adjusting position of the actuator 115 and/or orientation of the vanes of the VGT 111.

The vehicle control module 108 performs closed loop control of the turbocharger 104. The vehicle control module 108 may control boost pressure of the compressor 109 based on a pressure indicated by a temperature manifold air pressure (TMAP) sensor 151, a temperature of the intake manifold 116, and/or a temperature indicated by a temperature sensor 152. The vehicle control module 108 may reduce the amount of boost pressure out of the compressor 109 based on the temperature indicated by the temperature sensor 152. The temperature sensor 152 may indicate a compressor outlet temperature (COT) or a CAC inlet temperature. The temperature sensor 152 may be attached to the conduit 126 between the compressor 109 and the CAC 114. The vehicle control module 108 may also control operation of the turbocharger 104 based on other sensor data and non-sensor information. The other sensor data may be from, for example, a compressor inlet temperature (or induction air temperature) sensor 154 and additional sensors 156. The additional sensors 156 may include a fuel sensor 158, an ambient temperature sensor 160, a throttle position sensor 162, an engine speed sensor 164, and/or other sensors 168. One or more of the fuel sensors 158, throttle position sensor 162 and engine speed sensor 164 may be used to determine load on the engine 103. The other sensors 168 may include a vehicle speed sensor.

The engine exhaust braking system 101 may further include an engine speed sensor 164, a crank position sensor 166, a crankcase pressure sensor 167, an exhaust manifold pressure sensor 169, and a valve control assembly 170. The engine speed sensor 164 detect speed of the engine 103. The crank position sensor 166 detects a position of a crankshaft of the engine 103. The crankcase pressure sensor 167 detects a pressure within a crankcase of the engine 103. The exhaust manifold pressure sensor 169 detects a pressure within the exhaust manifold 134, which represents pressures on exterior sides of the exhaust valves 105 of the engine 103. The exhaust manifold pressure sensor 169 may be replaced with other exhaust and/or turbo pressure sensors, such as a turbo inlet pressure sensor detecting pressure within an inlet of the turbocharger 104. The inlet of the turbocharger 104 may be an inlet of the VGT 111.

The valve control assembly 170 may include mechanical and/or electronic actuators for controlling positions of intake valves 107 and exhaust valves 105 of the engine 103. The opening and closing of the intake and exhaust valves 107, 105 may be controlled by the vehicle control module 108. Opening and closing of the exhaust valves 105 may also be controlled by the equalization module 102. The equalization module 102 may control the opening and closing of the exhaust valves 105 based on outputs of the sensors 164, 166, 167, 169, and/or other sensors such as camshaft position sensors.

A memory 172 may be connected to the vehicle control module 108 and store data collected from the sensors 151, 152, 154, 156, 169, threshold values, limit values, calibration values, timing values, thresholds, and/or other data, as described below. The memory 172 may be separate from the vehicle control module 108 or included as part of the vehicle control module 108.

FIG. 2 shows a portion 200 of the engine exhaust braking system 101 of FIG. 1. The engine exhaust braking system 101 includes the engine 103, the equalization module 102 and the memory 172. The engine 103 includes exhaust valves 105, which are controlled by the valve control assembly 170. The valve control assembly may operate as a Jake Brake and/or in a modified Jake Brake operational mode. The modified Jake Brake operational mode includes reopening exhaust valves during intake strokes of the engine 103. The equalization module 102 control states of the exhaust valves 105 during certain conditions and during intake strokes of the cylinders 130 of the engine 103. The equalization module 102 may execute an exhaust valve pressure equalization algorithm 212 to equalize pressures across the exhaust valves 105 or a selected one or more of the exhaust valves 105. The states of the exhaust valves 105 may be controlled based on timing of strokes of the engine 103, valve timing, crankshaft position, camshaft position, estimated pressures in the cylinders 130 of the engine 103, estimated pressures in an exhaust manifold of the engine 103, engine speed, pressures in a crankcase of the engine 103, etc.

The memory 172 may store sensor data 220 collected from the above-stated sensors, valve timing information 222 and other data 224. The valve timing information may include opening and closing times, for example, relative to positions of the camshaft and/or crankshaft of the engine 103 and timing of intake, expansion, compression and exhaust strokes of the engine 103. The exhaust valves 105 may be reopened during intake strokes based on the valve timing information 222.

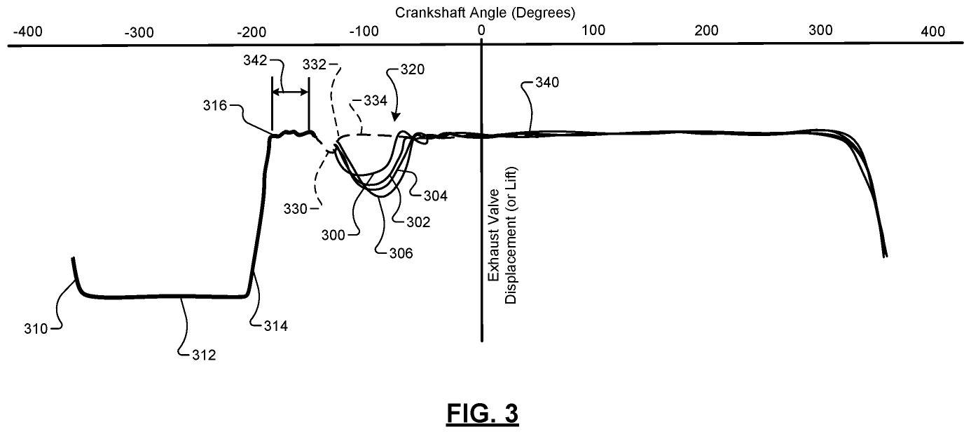

FIG. 3 shows a plot of exhaust valve displacement (or lift) versus crankshaft angle illustrating uncontrolled reopening of an exhaust valve (e.g., one of the exhaust valves of the engine 103 of FIGS. 1-2) and controlled reopening of the exhaust valve. Four curves 300, 302, 304, 306 are shown for four respective speeds of the engine 103. As an example, the speeds associated with the curves 300, 302, 304, 306 may be 4200 RPM, 4400 RPM, 4600 RPM and 4800 RPM, respectively.

The curves 300, 302, 304, 306 illustrate opening of the exhaust valve during an exhaust stroke and reopening of the exhaust valve during an intake stroke. The line segments 310 illustrate the exhaust valve being opened in a controlled manner. The line segments 312 illustrate the exhaust valves in a fully open controlled state. The line segments 314 illustrate the exhaust valves being closed in a controlled manner. At point 316, the exhaust valve is closed and the intake stroke beings for the corresponding cylinder of the engine 103. The line segments 340 illustrate states of the exhaust valve during intake strokes followed by expansion and compression strokes when the exhaust valve is traditionally in a closed state unless uncontrollably opened.

Without equalizing pressure across the exhaust valve and while the engine 103 is being operated as an engine brake, pressure within the exhaust manifold 134 increases and can cause the exhaust valve to open, designated by a high-pressure pulse (or dipped section) of each of the curves 300, 302, 304, 306 designated by arrow 320. The exhaust valve is opened in an uncontrolled and unscheduled manner. The uncontrolled reopening is however predictable and can occur at the same time in different intake strokes for a same engine speed. The magnitude of the exhaust valve lift and/or displacement from a closed position and duration of the opening of the exhaust valve increases with increase in engine speed as illustrated in FIG. 3.

The equalization module 102 of FIGS. 1-2 controls the state of the exhaust valve to prevent uncontrolled unscheduled reopening of exhaust valves. In the example shown, the equalization module 102 opens the exhaust valve prior to or when the pressure would normally begin to build in the exhaust manifold 134. The controlled reopening of the exhaust valve is shown by dashed curve 330. The magnitude and the duration of the opening may be controlled and predetermined based on the speed of the engine 103. The magnitude and/or duration may be increased with increased speed.

In an embodiment, instead of reopening and then fully closing the exhaust valve, the equalization module 102 opens the exhaust valve and then partially closes the exhaust valve and from an intermediate partially closed state gradually closes the exhaust valve over an extended period to minimize chances of the pressure within the exhaust manifold 134 from increasing during the intake stroke. The intermediate partially closed state is designated by point 332 and the gradual closing is designated as 334. Time between when the exhaust valve is in the intermediate partially closed states to time when the exhaust valve is in the fully closed state is longer than time between when the exhaust valve is reopened to time when the exhaust valve is in the intermediate closed states

As an example, the equalization module 102 may, during the intake strokes, open the exhaust valve 2-5 micrometers (μm), partially close the exhaust valve to 0.5-2 μm and then gradually close the exhaust valve to a fully closed state. An example duration of the reopening is shown in FIG. 3. Durations of reopening events may be different than shown in FIG. 3. These values are provided as examples and may be different depending on the application.

In an embodiment, the exhaust valve is reopened at a point in time within a 25°-35° window, designated 342 in FIG. 3. In another embodiment, the window is 30° in duration. The window 342 may begin at the end of the exhaust stroke or beginning of the intake stroke (e.g., at point 316) and/or may end when the pressure in the exhaust manifold is expected to begin increasing. In another embodiment, the window ends after the pressure in the exhaust manifold begins increasing but prior to the pressure in the exhaust manifold exceeding a first predetermined threshold and/or a pressure differential across the exhaust manifold exceeding a second predetermined threshold. The first predetermined threshold may be 5-20% of a predetermined possible peak in pressure build up in the exhaust manifold 134 if modified Jake Brake operation is not performed or 5-20% of a pressure needed to open the exhaust valves. The second predetermined threshold may be 5-20% of when the pressure differential would cause the exhaust valves to open.

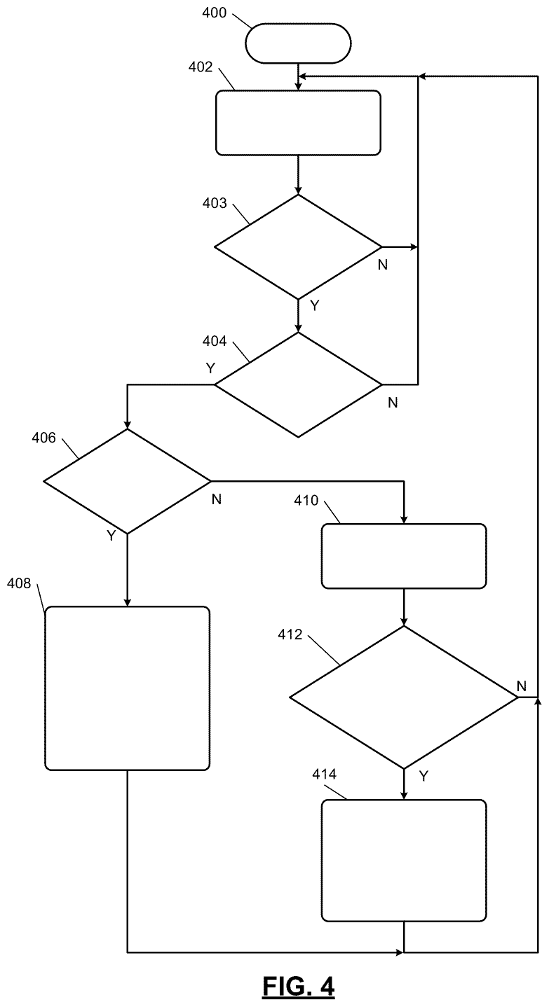

FIG. 4 shows a method of equalizing pressures across exhaust valves of an engine. The engine exhaust braking system 101 of FIGS. 1-2 may be operating according to this method. The following operations may be iteratively performed and may be performed by the equalization module 102. The method may begin at 400. At 402, sensor data is collected and/or stored in the memory 172.

At 403, the equalization module 102 may determine whether the engine speed is greater than or equal to a set predetermined threshold (e.g., 3200 RPM). The reopening of exhaust valves to equalization pressures across exhaust valves may be performed when the engine 103 is in a predetermined motored speed bandwidth (i.e., operating within a predetermined speed range (e.g., 3200-4800 RPM)). The set predetermined threshold may be different for different engines. If yes, operation 404 is performed, otherwise operation 402 may be performed.

At 404, the equalization module 102 determines the vehicle control module 108 is operating in an engine exhaust braking mode. This may occur when the speed of the engine 103 is greater than the set predetermined threshold. When load on the engine decreases, such that speed of the corresponding vehicle increases above a target speed, the vehicle control module 108 may operate in the engine exhaust braking mode to reduce speed of the vehicle. The vehicle control module 108 may downshift to increase the speed of the engine 103 in order to enable operation in the engine exhaust braking mode. The engine 103 may only be operated in the engine exhaust braking mode when the engine speed is greater than or equal to the set predetermined threshold. The vehicle control module 108 may prevent operating in the engine exhaust braking mode when the speed of the engine 103 is less than the set predetermined threshold. If operating in the engine exhaust braking mode, operation 406 may be performed, otherwise operation 402 may be performed.

At 406, the equalization module 102 may determine whether to control exhaust valve pressure equalization based on timing and/or pressures. If based on timing, operation 408 may be performed. If based on pressures, operation 410 may be performed. In another embodiment, exhaust valve pressure equalization is performed based on both timing and pressures.

At 408, the equalization module 102 engages modified Jake Brake operation to reopen each of a selected one or more exhaust valves during intake strokes of the selected one or more exhaust valves. In an embodiment, all of the exhaust valves are reopened. In one embodiment, the exhaust valves that are most likely prone to uncontrollably reopening during intake strokes are reopened and the exhaust valves that are least likely to reopen uncontrollably during the intake strokes are not reopened using modified Jake Brake operation. This selection may be predetermined, and the controlled reopening may be based on crankshaft and/or camshaft positions, exhaust valve timing, timing of exhaust and intake strokes, etc. The timing of the reopening may be predetermined and stored in the memory 172. As an example, the selected exhaust valves may be reopened during, for example, a 25°-35° window beginning at the beginning of corresponding intake strokes and/or end of corresponding exhaust strokes. The reopening of the exhaust valves refers to the opening of the exhaust valves during intake strokes after the exhaust valves were already opened during the last exhaust strokes. The magnitudes and durations of the reopening of each of the selected exhaust valves may also be predetermined and stored in the memory 172. The magnitudes in exhaust valve lift and/or displacement from a closed position and durations may be based on the engine speed. In an embodiment, a table is used to relate engine speed to magnitudes and durations.

An engine having an uneven firing order may have certain cylinders firing 90° apart, other cylinders firing 180° apart, and yet other cylinders firing 270° apart. The cylinders with the least amount of separation from when a previous cylinder was fired are the weak cylinders because these cylinders have the least amount of time to intake and compress air. For example, a cylinder that is 90° apart from a previous cylinder has much less time than a cylinder that is 270° apart from a previous cylinder. In an embodiment, the cylinders that are 90° from a previous cylinder are selected. In another embodiment, the cylinders that are 90° from a previous cylinder are selected for a first engine speed range and other cylinders are selected based on pressure differentials across exhaust valves for a second engine speed range that is higher than the first engine speed range. The weak cylinders may be determined based on firing order of the cylinders and analysis of firing timing and exhaust valve timing.

An exhaust pressure differential across an exhaust valve refers to a difference between a pressure in an exhaust manifold and a pressure in a corresponding cylinder of the exhaust valve. An exhaust pressure differential may be estimated based on signals from the engine speed sensor 164, the crankcase pressure sensor 167, the exhaust manifold pressure sensor 169.

For an engine having a flat plane crankshaft such that exhaust valves are alternatively opened 180° apart, all exhaust valves may be equally likely to reopen if based solely on exhaust valve timing. For this type of crankshaft and engine, prior historical data indicating which one or more of the exhaust valves uncontrollably reopens may be used to select the one or more exhaust valves to reopen using modified Jake Brake operation. As an alternative, exhaust pressures and/or exhaust valve pressure differentials may be used to select the exhaust valves to be controllably reopened.

The selected exhaust valves may be reopened multiple times during a same intake stroke. A second exhaust valve reopening event of an intake stroke may be a set a predetermined amount of time after the first reopening of the exhaust valve. Operation 402 may be performed subsequent to operation 408.

The described timed reopening helps equalize pressures across the exhaust valves providing control to the extent of exhaust valves. This minimizes magnitudes and durations of exhaust valve reopening events including preventing uncontrollable opening of the exhaust valves.

At 410, the equalization module 102 the equalization module 102 may determine pressure differentials across the exhaust valves of the engine 103, as described above. At 412, the equalization module 102 may determine whether one or more of the pressure differentials of the exhaust valves is greater than or equal to a second predetermined threshold. The second predetermined threshold may refer to a preselected percentage (e.g., 5-20%) of differential pressure needed to reopen the one or more exhaust valves. If yes, operation 414 may be performed, otherwise operation 402 may be performed.

At 414, the equalization module 102 engages the modified Jake Brake operation to open each of the one or more exhaust valves during corresponding intake strokes. Each of the one or more exhaust valves may be reopened one or more times during each of the intake strokes of the respective cylinders.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The examples disclosed herein include equalizing pressures across exhaust valves of an engine during intake strokes of the engine. Modified Jake Brake operation is implemented to intentionally reopen exhaust valves. The result of this is increased valve and seat durability and thus engine durability and improved loading performance including improved towing performance. Improved towing engine RPM control capability is provided through management of exhaust valve opening. By reopening the exhaust valves, less gas from the exhaust manifold reenters the cylinders of the engine during intake strokes. The magnitudes and durations of the exhaust valve reopenings are less than the magnitudes and durations of the uncontrollable reopenings that can occur if the modified Jake Brake operation is not performed. This prevents loss in negative torque due to uncontrolled reopening of the exhaust valves and prevents “jerkiness” in operation of the engine, which is often associated with uncontrolled reopening of exhaust valves. The jerkiness can be pronounced over time due to wearing of engine components. This wearing of engine components is typically not accounted for in calibrations of control systems and can increase jerkiness. The controlled and scheduled reopening of exhaust valves as disclosed herein minimizes exhaust gases reentering cylinders and being recompressed and minimizes and/or eliminates uncontrolled reopening of the exhaust valves and thus prevents jerkiness. This results in higher consistent negative torque and improved feel and control.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An engine exhaust braking system comprising:
a valve control system for controlling states of exhaust valves of an engine; and
a control module comprising a memory configured to store an exhaust valve pressure equalization algorithm, wherein the control module is configured to execute instructions of the exhaust valve pressure equalization algorithm, the instructions including
determining whether the engine is operating in an engine exhaust braking mode, and
in response to the engine operating in the engine exhaust braking mode, controlling the valve control system to initialize reopening of one or more of the exhaust valves at beginnings of corresponding intake strokes of the engine to equalize pressures between interior and exterior sides of the one or more exhaust valves.

2. The engine exhaust braking system of claim 1, further comprising an engine speed sensor configured to detect a speed of the engine,
wherein the control module is configured to control the reopening of the one or more of the exhaust valves based on the speed of the engine.

3. The engine exhaust braking system of claim 1, wherein the reopening of the one or more exhaust valves is controlled and scheduled.

4. The engine exhaust braking system of claim 1, wherein the control module is configured to reopen the one or more exhaust valves a plurality of times during the corresponding intake strokes of the engine.

5. The engine exhaust braking system of claim 1, wherein the control module is configured to, during the corresponding intake strokes of the engine, reopen the one or more exhaust valves and then partially close the one or more exhaust valves to intermediate closed states and then gradually close the one or more exhaust valves to fully closed states.

6. The engine exhaust braking system of claim 5, wherein time between when the one or more exhaust valves are in the intermediate partially closed states to time when the one or more exhaust valves are in the fully closed states is longer than time between when the one or more exhaust valves are reopened to time when the one or more exhaust valves are in the intermediate partially closed states.

7. The engine exhaust braking system of claim 1, further comprising:
a crankcase pressure sensor detecting pressure within a crankcase of the engine; and
an exhaust pressure sensor or a turbocharger inlet pressure sensor detecting a pressure indicative of a pressure on an exhaust side of the one or more exhaust valves,
wherein the control module is configured, based on the pressure within the crankcase and the pressure indicative of the pressure on the exhaust side of the one or more exhaust valves, to estimate pressure differentials across the one or more exhaust valves, and based on the pressure differentials, reopen the one or more exhaust valves during the corresponding intake strokes of the engine.

8. The engine exhaust braking system of claim 1, wherein the one or more exhaust valves are on weak cylinders of the engine, the weak cylinders refer to cylinders having the shortest amount of time to intake and compress air as compared to other cylinders of the engine, the shortest amount of time is determined based on an uneven firing order, which is used when an ignition system of the engine is enabled.

9. (canceled)

10. A vehicle propulsion system comprising:
at least one sensor detecting one or more parameters of the engine; and
the engine exhaust braking system of claim 1,
wherein
the engine is a diesel engine, and
the control module is configured to reopen the one or more exhaust valves based on the one or more parameters.

11. A method of equalizing pressures across exhaust valves of an engine, the method comprising:
controlling states of the exhaust valves of the engine via a valve control system;
determining whether the engine is operating in an engine exhaust braking mode; and
in response to the engine operating in the engine exhaust braking mode, controlling the valve control system to initialize reopening of one or more of the exhaust valves at beginnings of corresponding intake strokes of the engine to equalize pressures between interior and exterior sides of the one or more exhaust valves.

12. The method of claim 11, further comprising:
detecting a speed of the engine; and
controlling the reopening of the one or ore of the exhaust valves based on the speed of the engine.

13. The method of claim 11, wherein the reopening of the one or more exhaust valves is controlled and scheduled.

14. The method of claim 11, further comprising reopening the one or more exhaust valves a plurality of times during the corresponding intake strokes of the engine.

15. The method of claim 11, further comprising, during the corresponding intake strokes of the engine, reopening the one or more exhaust valves and then partially closing the one or ore exhaust valves to intermediate closed states and then gradually closing the one or more exhaust valves to fully closed states.

16. The method of claim 15, wherein time between when the one or more exhaust valves are in the intermediate partially closed states to time when the one or more exhaust valves are in the fully closed states is longer than time between when the one or more exhaust valves are reopened to time when the one or more exhaust valves are in the intermediate partially closed states.

17. The method of claim 11, further comprising:
detecting pressure within a crankcase of the engine;
detecting a pressure indicative of a pressure on an exhaust side of the one or more exhaust valves; and
based on the pressure within the crankcase and the pressure indicative of a pressure on the exhaust side of the one or more exhaust valves, estimating pressure differentials across the one or more exhaust valves, and based on the pressure differentials, reopening the one or more exhaust valves during the corresponding intake strokes of the engine.

18. The method of claim 11, wherein the one or more exhaust valves are on weak cylinders of the engine, the weak cylinders refer to cylinders having the shortest amount of time to intake and compress air as compared to other cylinders of the engine, the shortest amount of time is deters wined based on an uneven firing order, which is used when an ignition system of the engine is enabled.

19. (canceled)

20. The method of claim 11, further comprising:
detecting one or more parameters of the engine; and
reopening the one or more exhaust valves based on the one or more parameters.

21. The engine exhaust braking system of claim 8, wherein exhaust valves of the other cylinders of the engine are not reopened during corresponding intake strokes of the engine.

22. The method of claim 18, further comprising refraining from reopening exhaust valves of the other cylinders of the engine during corresponding intake strokes of the engine.
